(19) United States
(12) Patent Application Publication
(10) Pub. No.: US 2025/0170832 A1
(43) Pub. Date: May 29, 2025

(54) INK JET PRINTING SYSTEM

(71) Applicant: CANON KABUSHIKI KAISHA, Tokyo (JP)

(72) Inventors: Natalja Slawny, Munchen (DE); Artur Ebert, Olching (DE); Volker Schimscha, Haar (DE)

(21) Appl. No.: 18/956,773

(22) Filed: Nov. 22, 2024

(30) Foreign Application Priority Data
Nov. 24, 2023 (EP) 23212042.8

(51) Int. Cl. B41J 3/44; B41J 11/00; B41J 29/00; G01N 21/86

(52) U.S. Cl. CPC B41J 3/44; B41J 11/0022; B41J 29/00; G01N 21/86; G01N 2021/8663

(57) ABSTRACT

A system for ink-jet printing including a printing device, a fixing device, a varnish applicator, a gloss sensor system and a reaction unit. The printing device is configured to print primers and inks onto a substrate, the fixing device is configured to fix the printed-on primer and the printed-on ink to the substrate, the varnish applicator (300) is configured to fix a varnish on the printed and fixed substrate.

### CROSS-REFERENCE TO RELATED APPLICATIONS

This application claims the benefit of European Patent Application No. 23212042.8 filed Nov. 24, 2023, which is hereby incorporated by reference herein in its entirety.

### BACKGROUND OF THE DISCLOSURE

### Field of the Disclosure

The disclosure relates to a system for ink jet printing with a printing device, a fixing device and a varnish applicator.

### Description of the Related Art

It is known to provide a system for ink jet printing, which has a printing device, a fixing device, and a varnish applicator.

Typical ink jet printing devices provide printheads that are provided with ink ejection nozzles. As a rule, these are arranged above a substrate run and are arranged to eject ink onto a substrate. For better coagulation or solidification of the ink, it is furthermore possible to provide printheads for the application of a primer, which are arranged in front of the printheads for ink-jet printing in the printing direction. The primer can improve the coagulation by pretreating the surface, so that solidification in situ is contributed by avoiding separation or smearing of the ink by destabilization. It can increase the adhesion of the ink applied below, so that flaking or smearing of the ink is avoided. It can also regulate the absorption of the ink into the material and prevent the penetration of pigments and color particles into the material. It can also help the ink to dry on the surface more quickly.

Typical fixing devices generally have one or more hot blowers. Heat radiators or heating elements on the substrate guides are also conceivable. These serve to dry the printed-on primer and the printed-on ink and thus to fix it. Depending on the ink, UV radiators and other forms of fixing devices may also be provided. The fixing device is mounted downstream of the printing device in the printing direction or substrate running direction.

Typical varnish applicators consist of a flexo varnish unit. This is provided with a varnish-coated applicator roller, which is adapted to apply a varnish, in particular a matte, protective or glossy varnish, mostly water-based, but not limited to, to a transfer roller and from there to apply it to a substrate with a printed and fixed primer and a printed and fixed ink. Alternatively, UV varnish may also be conceivable. The applicator roller is also referred to as the scoop roller or screen roller, in particular as the “anilox roller.” Furthermore, an impression roller or impression cylinder is provided so that the substrate is transported between the transfer roller and the impression cylinder. However, it is also conceivable to have varnish print heads. The varnish is used to make the printed image robust against abrasion, but also in particular to achieve a certain gloss.

The primer can interact with the varnish during application of the varnish in a manner similar to that previously interacted with the ink. This can cause problems.

A possible problem is a varnish failure. Varnish is no longer applied to the substrate, since it has already been cured on the applicator roller during interaction with the primer by agglomeration of the solid particles.

Another possible problem is a reduction in gloss on the substrate. The gloss value normally achievable without interaction with primer is greatly reduced by interaction with the primer. Either no more varnish is applied to the substrate or the interaction with the primer leads to a poorer flowing of the varnish on the substrate. The resulting gloss difference over the printing surface is clearly visible on the printed substrate and is unacceptable.

In the case of a flexo varnish unit, a non-uniform spacing or nip of the rollers over the printing width can also lead to a non-uniform varnish image, which is visible as a difference in gloss. Vibrations caused by the device can also lead to visual frequency-imaging gloss differences. The wear of the surface of the transfer roller, which generally has clichés, blankets or sleeves, can limit the quality of the coating. The transfer roller is also referred to as a “print roller.”

All of the varnish problems mentioned lead to the fact that, during the printing process, regular visual checks of the printed and varnished substrate must be carried out at the end of a printing line. For visual inspection, individual sheets must be removed and not transported to the final stack. So-called proof trays can be created for this purpose. The time between occurrence or occurrence of gloss defects and the detection or stop of the production can vary greatly and depends on the frequency of the manual control. Pressure samples produced during this time must be sorted out and discarded in the event of a non-uniform application or skew.

U.S. Pat. Pub. No. 2006/0021535 A1, U.S. Pat. Pub. No. 2016/0288544 A1 and U.S. Pat. Pub. No. 2014/0184680 A1 disclose the use of a gloss sensor in ink jet printing. However, they do not solve the problem of wide or length-resolved gloss differences.

A solution for the problems described above is sought.

### SUMMARY OF THE DISCLOSURE

A system for ink jet printing according to the present disclosure. Further embodiments are specified are evident from the present description and the associated figures.

The disclosure relates to an ink jet printing system comprising a printing device, a fixing device, a varnish applicator, a gloss sensor system and a reaction unit.

### BRIEF DESCRIPTION OF THE DRAWINGS

FIG. 1 is a schematic side view of a system for ink jet printing.

### DESCRIPTION OF THE EMBODIMENTS

The printing device is designed to print primers and inks on a substrate. For this purpose, it has, in particular, ink-jet printing heads from which primer drops and ink drops are ejected onto the substrate by means of electrical or thermal pulses. The fixing device is set up to fix the printed primer and the printed ink. For this purpose, it has, in particular, a heating device such as a fan or a radiant heater. The varnish applicator is designed to apply a varnish to the printed and fixed substrate. In particular, the varnish applicator has for this purpose a flexographic printing unit with an applicator roller, a transfer roller and an impression cylinder. In this case, the applicator roller is arranged to apply a varnish to a transfer roller and from there to the substrate after fixing. The gloss sensor system is set up to detect gloss values of the substrate after coating with a specific width resolution and a specific length resolution. The reaction unit is set up to initiate at least one measure when a condition dependent on the gloss values occurs.

In a particularly advantageous embodiment, the gloss sensor system is set up to detect gloss values over an entire width and over an entire length of the substrate. In this way, local gloss differences on the entire substrate can advantageously be detected.

Preferably, a gloss fixing device is mounted downstream of the varnish applicator and is arranged to fix the applied varnish. This is advantageous since in this way a substrate with a dried varnish can be dispensed.

In particular, the gloss sensor is arranged in the printing direction upstream of the varnish fixing device and/or downstream of the varnish fixing device. A measurement of the gloss values before and after the varnish fixing device advantageously allows more precise statements about the reason for varnish differences.

The reaction device is particularly preferably set up to compare the measured gloss values with a reference gloss value and if at least one of the measured gloss values deviates from the reference gloss value as a condition, at least one measure is initiated.

Without limiting the generality, it is conceivable for the gloss sensor system to have bite-optical gloss sensors and/or ultrasonic gloss sensors and/or capacitive gloss sensors and/or digital image processing systems. Bite-optical gloss sensors are devices which are set up for measuring the gloss to analyze an incident and an outgoing light beam using the method of the bidirectional scatter distribution function. The sensor measures the intensity of the reflected light at different angles and then calculates the gloss value of the surface based on these measurements. Other angular optical gloss sensors are also conceivable. These are the most commonly known gloss sensors.

It is particularly advantageous if the gloss sensor system has a certain number of gloss sensors in the width direction, which are set up to detect gloss values in width resolution. For this purpose, the gloss sensor system preferably has between three and thirty gloss sensors in the width direction, even more preferably five to twenty, even more preferably eight to fourteen. Preferably, the gloss sensors arranged in the width direction are arranged to detect gloss values in the pressure direction in succession at a certain frequency. This is particularly advantageous since in this way gloss values can be detected over the entire substrate with a good resolution.

In a particularly advantageous embodiment, at least one measure consists in triggering a warning signal, in particular visibly on an operating surface or acoustically. For this purpose, the user interface may have a display or at least one warning lamp. In this way, the operator advantageously receives an indication that the varnish quality is to be tested. This allows rapid intervention in production and reduced waste.

Furthermore, at least one measure preferably consists in reducing a quantity of primers printed on by the printing device, so that advantageously fewer primers come to rest on a surface of the substrate. This is particularly advantageous when at least one measured gloss value is smaller than the reference gloss value by more than one threshold value. If less primer is printed onto the substrate, less primer can also interact with the varnish, as a result of which a measured gloss value can be increased.

In particular, at least one measure consists in adapting a drying setting in the fixing device. When more is dried, more primer can be absorbed by the substrate, which means that less primer is available for interaction with the varnish. This also allows a measured gloss value to be increased.

In a further advantageous embodiment, at least one measure consists in adapting a viscosity and/or a PH value of the varnish. This can be done, for example, by supplying varnish or water. As a result, a measured gloss value can advantageously be increased or reduced.

The reaction device is preferably set up for this purpose when, as a condition, gloss values averaged over a pressure width have a slope or a gradient which exceeds a threshold value, at least one measure is initiated.

In particular, at least one measure consists in automatically moving one of the three rollers of the application roller, transfer roller and impression cylinder, particularly preferably on a side which has a lower gloss value. A method of moving the transfer roller is particularly advantageous. In this way, a more uniform coating of varnish can be achieved. It is also conceivable for a second warning signal to be triggered visibly on a user interface.

In a further advantageous embodiment, the reaction device is set up to initiate at least one measure if a condition occurs that a standard deviation of the gloss values determined statistically over the running time exceeds a threshold value. In this way, vibrations of the varnish applicator can advantageously be detected and it can be concluded that components are worn.

In particular, at least one measure consists in outputting a third warning signal. In this way, it can be recognized at an early stage that spare parts must be replaced.

Overall, the disclosure, with all its different embodiments, has the advantage that an insufficient varnish quality can be detected more quickly. The faster and/or automated response made possible can increase productivity and reduce wastage or waste.

Further features, embodiments and advantages are evident from the drawing and the following description of the figures. It is noted that the combination of features is not to be regarded as limiting. The individual disclosed features are also to be regarded as originally disclosed, detached from the concrete embodiments in any conceivable combination.

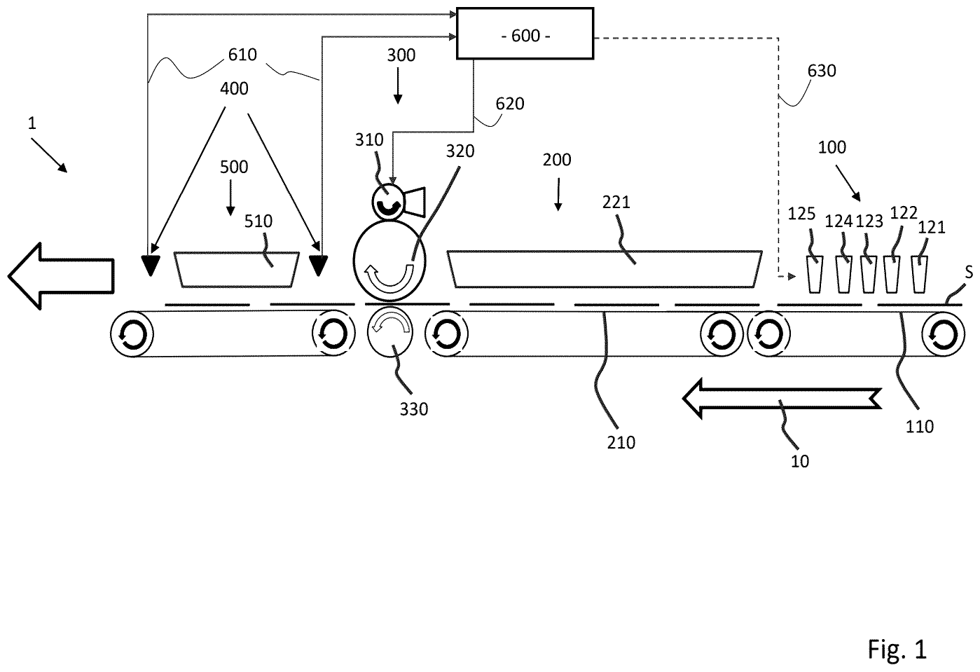

In FIG. 1, a system for ink jet printing is shown in a schematic side view and designated by 1.

The system 1 has a printing device 100, a fixing device 200, a varnish applicator 300, a gloss sensor 400 and a varnish fixing device 500. A printing direction of the system is indicated by an arrow and denoted by 10.

The printing device 100 here has a printing substrate transport device 110. The printing substrate transport device here consists of two guide rollers on which an endless belt is guided. The printing substrate transport device is designed to transport or guide a substrate S among a number of print heads.

The print heads are arranged here in five print head modules 121-125. A first print head module 121 is arranged to apply primers to the substrate S. A second printhead module 122 is arranged to apply black ink to the substrate S. A third print head 123 module is arranged to apply cyan-colored ink to the substrate. A fourth printhead module 124 is arranged to apply magenta ink to the substrate. A fifth printhead module 125 is arranged to apply yellow ink to the substrate. The disclosure is not limited to the colors mentioned. Thus, a print head module for white ink or print head modules for further colors are conceivable.

The fixing device 200 is located downstream of the printing device 100 in the printing direction 10. The fixing device is set up to fix or dry the printed primer and the printed ink. For this purpose, a substrate fixing transport device 210 is provided here, which has two rollers and an endless belt in a manner comparable to the printing substrate transport device 110. Furthermore, one or more radiant heaters are provided in this embodiment. One or more heating blowers are also conceivable, but this is not shown in the figure.

A varnish applicator 300 is provided downstream of the fixing device 200 in the printing direction 10. The latter has an applicator roller 310 and a transfer roller 320. Furthermore, a varnish application device (not shown) is advantageously provided. This consists, for example, of a reservoir with a liquid tank, a pump or another mechanism. The reservoir can be filled with varnish. The application roller 310 can be sprayed with varnish, for example, or dipped into the varnish. The applicator roller 310 is arranged to apply a uniform layer of varnish to a transfer roller 320. When passing between transfer roller 320 and a counter-pressure cylinder 330, the varnish is applied to the substrate S. The impression cylinder 330 or the transfer roller 320 can be provided with a sleeve which is pushed onto a mandrel and which can be designed as a so-called coating sleeve. A pressure plate can be glued onto this plate.

A varnish fixing device 500 is arranged downstream of the varnish applicator 300 in the printing direction 10. The gloss sensor system 400 is arranged upstream and downstream of the varnish fixing device 500. The varnish fixing device 500 is here in the form of one or more heat radiators 510. The gloss sensor system 400 is designed to detect gloss values resolved in the width direction and in the length direction.

The reaction device 600 can be designed, for example, in the form of a control unit which is coupled at least to the gloss sensor system 400 via at least one input cable 610. In the figure there are two gloss sensors 400 depicted hence both could be coupled to the reaction device via both independent input cables 610 thereby getting two separate signals. The control unit or reaction device 600 can send signals to an operating unit with warning lights or to the varnish applicator 300 via the first output cable 620 and/or also to the printing device 100 via the second output cable 630 in order to trigger at least one desired reaction.

1. An ink jet printing system comprising:
a printing device;
a fixing device;
a varnish applicator;
a gloss sensor system; and
a reaction unit,
wherein the printing device is configured to print primers and inks on a substrate,
the fixing device is configured to fix the printed primer and the printed inks on the substrate(S),
the varnish applicator is configured to fix a varnish on the printed and fixed substrate,
the gloss sensor system is configured to detect gloss values of the substrate after the varnish application with a specific width resolution and a specific length resolution, and
the reaction unit being arranged to initiate a measure when a condition based on the gloss values occurs.

2. The ink jet printing system according to claim 1, wherein the gloss sensor system is arranged to detect gloss values over an entire width and over an entire length of the substrate.

3. The ink jet printing system according to claim 1, further comprising a varnish fixing device mounted downstream of the gloss applicator in a printing direction.

4. The ink jet printing system according to claim 3, wherein the gloss sensor system is arranged in the printing direction before and/or after the varnish fixing device.

5. The ink jet printing system according to claim 1, wherein the reaction unit is arranged to compare the measured gloss values with a reference gloss value, and when at least one of the measured gloss values deviates from the reference gloss value as a condition, to initiate at least one measure.

6. The ink jet printing system according to claim 1, wherein the gloss sensor system has bite-optical gloss sensors and/or ultrasonic gloss sensors and/or capacitive gloss sensors and/or digital image processing systems and/or angular optical gloss sensors.

7. The ink jet printing system according to claim 1, wherein the gloss sensor system has, in a width direction, between five and thirty-five gloss sensors that are arranged to detect gloss values in a printing direction successively at a certain frequency.

8. The ink jet printing system according to claim 1, wherein a measure includes triggering a warning signal, in particular on an operating surface, and/or in reducing a quantity of primer printed on by the printing device and/or in adapting a viscosity and/or a pH value of the varnish.

9. The ink jet printing system according to claim 1, wherein, when the condition occurs that gloss values have a slope or a gradient averaged over a printing width that exceeds a threshold value, the reaction unit is configured to initiate at least one measure, in particular the measure of automatically moving at least one roller from an applicator roller, a transfer roller and a back pressure cylinder of the varnish applicator, on a side that has a lower gloss value.

10. The ink jet printing system according to claim 1, wherein, when a condition occurs that a standard deviation of the gloss values determined statistically over a running time exceeds a threshold value, the reaction unit is configured to initiate a measure.
